(19) United States
(12) Patent Application Publication
(10) Pub. No.: US 2005/0124254 A1
(43) Pub. Date: Jun. 9, 2005

(54) Nonwoven fabric laminate having enhanced barrier properties

(75) Inventors: Jorge A. Santisteban, San Luis Potosi, S.L.P. (MX); Juana Rocio Guajardo Torres, San Luis Potosi, S.L.P. (MX)

Correspondence Address: WOOD, PHILLIPS, KATZ, CLARK & MORTIMER, 500 W. MADISON STREET, SUITE 3800, CHICAGO, IL, 60661, US

(73) Assignee: Polymer Group, Inc.

(21) Appl. No.: 10/991,558

(22) Filed: Nov. 18, 2004

Related U.S. Application Data
(63) Continuation of application No. 10/120,715, filed on Apr. 11, 2002.
(60) Provisional application No. 60/283,433, filed on Apr. 12, 2001.

(51) Int. Cl. D04H 1/00; D04H 5/00; D04H 3/00; D04H 13/00; D04H 1/56; B32B 5/26; D04H 3/16

(52) U.S. Cl. 442/382; 442/400; 442/401; 442/381; 442/332; 442/333

(57) ABSTRACT

A nonwoven fabric laminate embodying the principles of the present invention is configured as a multi-layer construct of a plurality of melt-extrusion layers, including at least one, and preferably a pair of outer spunbond layers, and a central, melt-blown barrier layer juxtaposed to the outer spunbond layers. At least one fo the layers, preferably the melt-blown layer, comprises a barrier-enhancing melt additive compound having a fluoroalcohol with a non-derivatized additive such as a fatty acid, more preferably a derivatized perfluoroalcohol with a non-derivatized additive, with a stearic ester of perfluoroalcohol in a hydrogenated tallow amide additive being presently preferred.

### CROSS-REFERENCE TO RELATED APPLICATION

This application is a continuation of U.S. Ser. No. 10/120,715, filed Apr. 11, 2002.

### TECHNICAL FIELD

The present invention relates generally to nonwoven fabrics, and more particularly to a nonwoven fabric laminate comprising spunbond and melt-blown layers, with the melt-blown layer exhibiting enhanced barrier properties by virtue of an additive comprising a fluoroalcohol, preferably a derivatized perfluoroalcohol, with a non-derivatized additive, such as a hydrogenated tallow amide.

### BACKGROUND OF THE INVENTION

Nonwoven fabrics formed from melt-extruded polymeric fibers and filaments have found widespread application by virtue of the manner in which the physical characteristics and properties of such fabrics can be selectively engineered. For some applications, such as for use in medical gowns and drapes, it is important that such nonwoven fabrics exhibit barrier properties, such as repellency to liquids such as body fluids, while providing vapor permeability for the comfort of users. To this end, nonwoven fabrics formed as laminates of juxtaposed spunbond, melt-blown, and spunbond layers, sometimes referred to as SMS fabrics, have proven particularly suitable. In these types of fabric constructs, the micro-fibers of the inner melt-blown layer provide highly desirable barrier properties, while the outer spunbond layers, formed from substantially continuous polymeric filaments, provide the desired strength and integrity. U.S. Pat. No. 4,041,203, to Brock et al., hereby incorporated by reference, is exemplary of such fabric laminates.

In the past, the barrier properties of such fabric laminates has been enhanced by including additives in the polymer melt, with fluorocarbon compounds having been used in the past. However, these types of melt additive compounds tend to flash and vaporize attendant to melt-extrusion of the polymeric material for web formation. PCT Publication No. WO95/26878, hereby incorporated by reference, discloses a fabric laminate formed with a fluorocarbon additive. U.S. Pat. No. 5,178,931, to Perkins et al., hereby incorporated by reference, also discloses a fabric laminate structure having barrier-enhancing additives. While such melt additives have provided the desired barrier-enhancing properties, such fluorocarbon compounds are believed to have undesirable environmental impact.

The present invention is directed to a nonwoven fabric laminate having enhanced barrier properties, desirably including enhanced alcohol repellency, which achieves its barrier properties without resort to fluorocarbon melt additives.

### SUMMARY OF THE INVENTION

A nonwoven fabric laminate embodying the principles of the present invention is configured as a multi-layer construct of a plurality of melt-extrusion layers, including at least one, and preferably a pair, of outer spunbond layers, each comprising substantially continuous, melt-extruded polymeric filaments. The laminate construct further includes a central, melt-blown barrier layer juxtaposed to the outer spunbond layers. The meltblown layer comprises discontinuous filamentary elements, formed from a polymer selected from the group consisting of polyolefins, polyesters, polyetheresters, and polyamide. At least one of the layers, preferably the melt-blown layer, comprises a barrier-enhancing melt additive compound having a fluoroalcohol with a non-derivatized additive such as a fatty acid, more preferably a derivatized perfluoroalcohol with a non-derivatized additive, with a stearic ester of perfluoroalcohol in a hydrogenated tallow amide additive being presently preferred. Notably, testing has shown that a fabric laminate having this melt additive exhibits barrier properties comparable to fabrics formed with fluorocarbon melt additives. Thus, the desired fabric repellency is achieved without undesirable environmental impact.

Other features and advantages of the present invention will become readily apparent from the following detailed description, and the appended claims.

### DETAILED DESCRIPTION

While the present invention is susceptible of embodiment in various forms, there is disclosed herein a presently preferred embodiment, with the understanding that the present disclosure is to be considered as an exemplification of the invention, and is not intended to limit the invention to the specific embodiment disclosed.

Nonwoven fabric laminates formed from juxtaposed spunbond, melt-blown, and spunbond (SMS) layers have found widespread application in medical uses such as hospital gowns and drapes. These types of laminate fabric constructs derive their desired strength characteristics from the outer spunbond layers, with the fine fiber structure of the inner melt-blown layer providing the desired barrier properties. Repellency to bodily fluids is desired, while breathability of the constructs provides the desired comfort for the wearer.

Heretofore, these types of laminate fabrics have been made from polyolefins, such as polypropylene, with fabrics formed from this type of polymer exhibiting a degree of inherent hydrophobicity, by virtue of the polymer resin. These types of fabric laminates are thus effective at providing a barrier to bodily fluids. However, these types of fabrics do not inherently exhibit the same repellency to certain liquids found in a medical environment, such as alcohol, isodine, and blood. As a consequence, it has typically been necessary to employ melt additives in the polymers from which one or more of the SMS layers is formed.

While fluorocarbon-based melt additives have been used in the past, experience has shown that these additives can have an undesirable environmental impact.

Efforts to employ alternatives to fluorocarbon compounds as melt additives have included use of perfluoroalcohol. However, experience has shown that this type of compound does not blend well with polymers, and does not provide the desired degree of repellency attendant to melt-extrusion formation of the fabric laminate layers.

The desired degree of blending of such a perfluoroalcohol has been achieved for formation of the nonwoven fabric of the present invention by use of a barrier-enhancing melt additive, which includes a fluoroalcohol (CF sub.3 CF sub.2 (CF sub.2) sub k. C sub.2 H sub.4 OH, where k is an integer between 2 and 12), and a non-derivatized additive, such as a fatty acid such as a hydrogenated tallow amide. In the preferred practice of the present invention, a barrier-enhancing melt additive compound has been employed, with the additive compound comprising a stearic ester of perfluoroalcohol and a hydrogenated tallow amide. This combination has been found to provide the desired repellency performance, with enhanced thermal-stability in comparison to a melt additive comprising 100% stearic ester of perfluoroalcohol.

The accompanying Table sets forth comparative data of air and water permeability and isodine, synthetic blood and isopropyl alcohol repellency, comparing a fabric laminate formed in accordance with the present invention with a comparable laminate construct having a fluorocarbon additive compound.

Significantly, the fabric laminate of the present invention provides both comparable air permeability and liquid repellency.

From the foregoing, numerous modifications and variations can be effected without departing from the true spirit and scope of the novel concept of the present invention. It is to be understood that no limitation with respect to the specific invention disclosed herein is intended or should be inferred. The disclosure is intended to cover, by the appended claims, all such modifications as fall within the scope of the claims.

TABLE 1

| | ^{a)}Air | | | | |
|---|---|---|---|---|---|
| | Permeability | ^{b)}Water | | | |
| | (meters³/ | Permeability | | ^{c)}Synthetic | ^{c)}Isopropyl |
| | meters²- | (hydrostatic | ^{c)}Isodine | Blood | Alcohol |
| | minutes | head, mm) | Repellency | Repellency | Repellency |
| SMS Fabric with no | 29.9 | 280 | 0 | 0 | 0 |
| additive (35 g/m²) | | | | | |
| SMS Fabric With | 15.5 | 359 | 5 | 5 | 5 |
| Fluorocarbon | | | | | |
| Additive (35 g/m²) | | | | | |
| Present SMS | 16.3 | 347 | 5 | 5 | 5 |
| Fabric (35 g/m²) | | | | | |
| SMS Fabric With No | 16.5 | 334 | 0 | 0 | 0 |
| Additive (45 g/m²) | | | | | |
| SMS Fabroc With | 12.5 | 416 | 5 | 5 | 5 |
| Fluorocarbon | | | | | |
| Additive (45 g/m²) | | | | | |
| Present SMS | 11.9 | 430 | 5 | 5 | 5 |
| Fabric (45 g/m²) | | | | | |
| ^{a)}EDANA 140.1-81 Air Permeability Test Method: To determine the air permeability of a fabric, samples are conditioned and placed upon the analysis area of a suction device. A seal in formed around the sample so as to secure the sample and prevent air from escaping during the test. A regulated quantity of air is aspired in order to work with | | | | | |
| # a depression of 196 Pa on the device's manometer. Upon the stabilization of pressure, the reading is retrieved from the graduated scale. | | | | | |
| ^{b)}EDANA 120.1-80 Repellency Test Method: To determine the water repellency of a fabric while subjected to a continuous increase in pressure, the samples are conditioned and fastened within the analysis area of the water column testing device. The sample is exposed to an increasing amount of water and pressure while being observed for any water leaks. Once the third drop of water | | | | | |
| # appears on the surface of the sample, the reading is taken from the testing device's manometer. | | | | | |

^{c)}Drop Repellency Test Method: To evaluate repellency properties, a piece of the fabric is placed on a flat and clean surface. The fabric side in contact with the liquid shall be the treated layer. Some drops of each liquid, such as Isodine, synthetic blood and Isopropanol, are quickly applied over the fabric sample, taking care in applying the same number of drops of each liquid.

a) EDANA 140.1-81 Air Permeability Test Method: To determine the air permeability of a fabric, samples are conditioned and placed upon the analysis area of a suction device. A seal in formed around the sample so as to secure the sample and prevent air from escaping during the test. A regulated quantity of air is aspired in order to work with a depression of 196 Pa on the device's manometer. Upon the stabilization of pressure, the reading is retrieved from the graduated scale.

b) EDANA 120.1-80 Repellency Test Method: To determine the water repellency of a fabric while subjected to a continuous increase in pressure, the samples are conditioned and fastened within the analysis area of the water column testing device. The sample is exposed to an increasing amount of water and pressure while being observed for any water leaks. Once the third drop of water appears on the surface of the sample, the reading is taken from the testing device's manometer.

c) Drop Repellency Test Method: To evaluate repellency properties, a piece of the fabric is placed on a flat and clean surface. The fabric side in contact with the liquid shall be the treated layer. Some drops of each liquid, such as Isodine, synthetic blood and Isopropanol, are quickly applied over the fabric sample, taking care in applying the same number of drops of each liquid.

Take time with a chronometer and after 15 minutes assess the liquid effect over the fabric.

The criteria for grading the repellency for each liquid is based on comparing the drop effect with some visual standard. The score range is 0 to 5 where a score of 0 is for a liquid that has penetrated the fibers completely and a score of 5 is for a drop that has kept its shape and has not penetrated the fibers.

The results within Table 1 show the SMS fabric of the present invention as having an optimal repellency performance when compared to the SMS fabric comprised of the fluorocarbon additive.

1. (canceled)

2. (canceled)

3. (canceled)

4. (canceled)

5. (canceled)

6. A method of providing a barrier to protect a human in a medical environment comprising the steps of:
providing at least one outer spunbond layer, said spunbond layer comprising substantially continuous, melt-extruded polymeric filaments;
providing at least a melt-blown barrier layer juxtaposed to said spunbond layer to form a nonwoven fabric laminate, said melt-blown layer comprising discontinuous melt-blown polymeric filamentary elements, said filamentary elements comprising a polymer selected from the group consisting of polyolefins, polyesters, polyetheresters, and polyamide,
wherein one or more of said layers contain a barrier-enhancing additive compound comprising a fluoroalcohol and a non-derivatized additive for enhancing the barrier properties of said barrier layer,
said barrier-enhancing additive compound comprising a derivatized perfluoroalcohol with a non-derivatized additive,
said fabric laminate exhibiting a Synthetic Blood Drop Repellency Test value of 5; and
forming one of a medical gown and a medical drape from said nonwoven fabric laminate to protect a human in a medical environment.

7. A method of providing a barrier in accordance with claim 1, wherein:
said barrier-enhancing additive compound comprises a stearic ester of perfluoroalcohol with a hydrogenated tallow amide additive.
